(19) United States
(12) Patent Application Publication
(10) Pub. No.: US 2011/0144803 A1
(43) Pub. Date: Jun. 16, 2011

(54) REAL-TIME DISTRIBUTED CONTROL SYSTEM, REAL-TIME DISTRIBUTED CONTROL METHOD, AND ROBOT

(75) Inventor: Saku EGAWA, Toride (JP)

(73) Assignee: Hitachi, Ltd.

(21) Appl. No.: 12/963,954

(22) Filed: Dec. 9, 2010

(30) Foreign Application Priority Data
Dec. 10, 2009 (JP) 2009-280166

(51) Int. Cl. G05B 15/02; B25J 9/00

(52) U.S. Cl. 700/245; 700/11; 901/50

(57) ABSTRACT

There is provided a real-time distributed control system which can prevent a delay of execution by a hard real-time control system. In the real-time distributed control system, a receiving computer includes a receiving component which receives a message, and an operation cycle obtaining unit which obtains the operation cycle of the receiving component upon activation of the system, and transmits a monitoring condition associated with the obtained operation cycle to a transmission-rate-monitoring-condition setting unit. A transmitting computer includes a transmitting component which transmits the message, the transmission-rate-monitoring-condition setting unit which sets the monitoring condition in a transmission-rate-monitoring-condition memory unit, and a transmission rate monitoring unit which monitors a transmission rate from the transmitting component based on the monitoring condition stored in the transmission-rate-monitoring-condition memory unit, and suppresses a transmission interval of the message when the transmission rate of the message does not satisfy the monitoring condition.

### CROSS-REFERENCE TO RELATED APPLICATION

The present application claims benefit of the filing date of Japanese Patent Application No. 2009-280166 filed on Dec. 10, 2009 which is incorporated herein by reference.

### BACKGROUND OF THE INVENTION

1. Field of the Invention

The present invention relates to a real-time distributed control system, a real-time distributed control method, and a robot which can suppress a delay of execution by a hard real-time control system.

2. Description of the Related Art

Control systems for robot/mechatronics devices need a real-time process in order to drive and control a physical mechanical device. Also, in order to make an equipped control device compact, a distributed control scheme using a plurality of small-scale computers is often used.

An example of a technology of enhancing the development efficiency of a software for such real-time distributed control system is “A Component-Oriented Software Configuration for Human Symbiotic Robot “EMIEW2””, Japan Society of Mechanical Engineering, Robotics and Mechatronics lecture presentation, 2008, 2P1-104 which discloses a message-driven component-oriented software framework. According to this technology, softwares are developed as software components function by function, and such components are combined together to develop an application software for a control system.

Each component has a virtual input/output unit which is called a port, and a message is exchanged between connected ports, thereby causing the components to operate cooperatively. Such a mechanism is realized by a middleware which is a common basic software, and a message communication between the components is executed via the middleware. When a component at a transmitting side of a message and a component at a receiving side of the message are run on different computers, the message is transmitted through a communication channel between the computers. When the transmitting side and the receiving side are both run on the same computer, the message is transmitted through a virtual communication channel realized by a software. Utilization of a component-oriented software framework facilitates combination and recombination of the components, so that the reusability of the component becomes high, thereby increasing the development efficiency.

A real-time distributed control system can be divided into a hard real-time unit and a soft real-time unit. A delay of a process is prohibited to the hard real-time unit, and the hard real-time unit needs to complete the process until a predetermined deadline time. In general, such a process is executed per a certain period. For example, a servo control corresponds to such a process. Such a process is often called a “control system”, but in order to distinguish such a process from a “control system” indicating the whole containing a soft real-time control system, the former is referred to as a “hard real-time control system”. The soft real-time unit causes no big problem when the process is slightly delayed. For example, a part which relates to an interface with a human and a process for planning and determining an action comprehensively correspond to that unit. Such a process is often called an “information system”.

In a control system for a robot, the soft real-time information system determines an action, transmits an operational instruction to the hard real-time control system, and the hard real-time control system controls a mechanical device to actuate the robot. In such a system in which the information system and the hard real-time control system are mixed, when the information system transmits a large amount of operational instruction messages to the hard real-time control system, the process by the hard real-time control system may be delayed. Hence, it is necessary to set the amount of messages to be transmitted to the hard real-time control system from the information system not to be large.

Conventionally, such a problem is dealt with a software designing in consideration of the amount of transmitting messages, but a possibility that excessive messages are generated due to a program error still remains. Also, when the component for transmitting a message is purchased from outside and the internal designing information thereof is hardly obtained, it brings about a problem that the maximum amount of messages remains unknown.

Also, in order to enhance the reliability of the system, it is desirable to provide a mechanism which monitors and restricts the amount of messages in the middleware. Although unrelated to a real-time control for a robot/mechatronics device, as an example of a related technology for monitoring the message amount, JP 2001-339465 A discloses a communication system which monitors the process amount based on messages, restricts the transmission rate when the process amount based on the messages to the same communication device destination exceeds a predetermined reference value, and then transmits a message.

### SUMMARY OF THE INVENTION

According to JP 2001-339465 A, it is determined whether or not to restrict the transmission of a message based on the “reference value”, but how to set such a reference value is not clarified. If a system developer needs to set such a value manually, in the case of a robot control system, a wide variety of components are used, and the allowable message amount varies. For this reason, a manual setting may bring about an error. Also, when a combination configuration of the components changes, the allowable message amount also changes, so that a setting must be made again, resulting in a troublesome work.

The present invention has been made in order to overcome the foregoing problems, and it is an object of the present invention to provide a real-time distributed control system, a real-time distributed control method, and a robot which can suppress a delay of execution by a hard real-time control system.

In order to accomplish the above-explained object, a first aspect of the present invention provides a real-time distributed control system including a first computer and a second computer, the second computer being configured to receive a message from the first computer to be controlled in a real-time manner, in which the second computer comprises: a receiving component which receives the message; and an operation cycle obtaining unit which obtains an operation cycle of the receiving component upon activation of the real-time distributed control system and which transmits a monitoring condition associated with the obtained operation cycle to the first computer, and the first computer comprises: a transmitting component which transmits the message; a transmission rate setting unit which sets the monitoring condition in a transmission-rate-monitoring-condition memory unit; and a transmission rate monitoring unit which monitors a transmission rate from the transmitting component based on the monitoring condition stored in the transmission-rate-monitoring-condition memory unit, and which suppresses a transmission interval of the message when the transmission rate of the message does not satisfy the monitoring condition.

### BRIEF DESCRIPTION OF THE DRAWINGS

FIG. 1 is a block diagram showing a real-time distributed control system according to an embodiment of the present invention;

FIG. 2 is a block diagram showing a hardware of the real-time distributed control system;

FIG. 3A is a block diagram showing a hierarchical structure of a software for the real-time distributed control system;

FIG. 3B is a block diagram showing a hierarchical structure of a software for the real-time distributed control system;

FIG. 4 is a sequence diagram showing an initial setting operation by the real-time distributed control system;

FIG. 5 is a sequence diagram showing an operation timing for a receiving component;

FIG. 6 is a sequence diagram showing an operation timing in a comparison example having no transmission rate monitoring unit;

FIG. 7 is a sequence diagram showing a timing of a monitoring/controlling operation by the real-time distributed control system of this embodiment; and

FIG. 8 is a sequence diagram showing a timing of another monitoring/controlling operation by the real-time distributed control system of this embodiment.

### DETAILED DESCRIPTION OF THE PREFERRED EMBODIMENT

An embodiment of the present invention will be explained in detail with reference to the accompanying drawings.

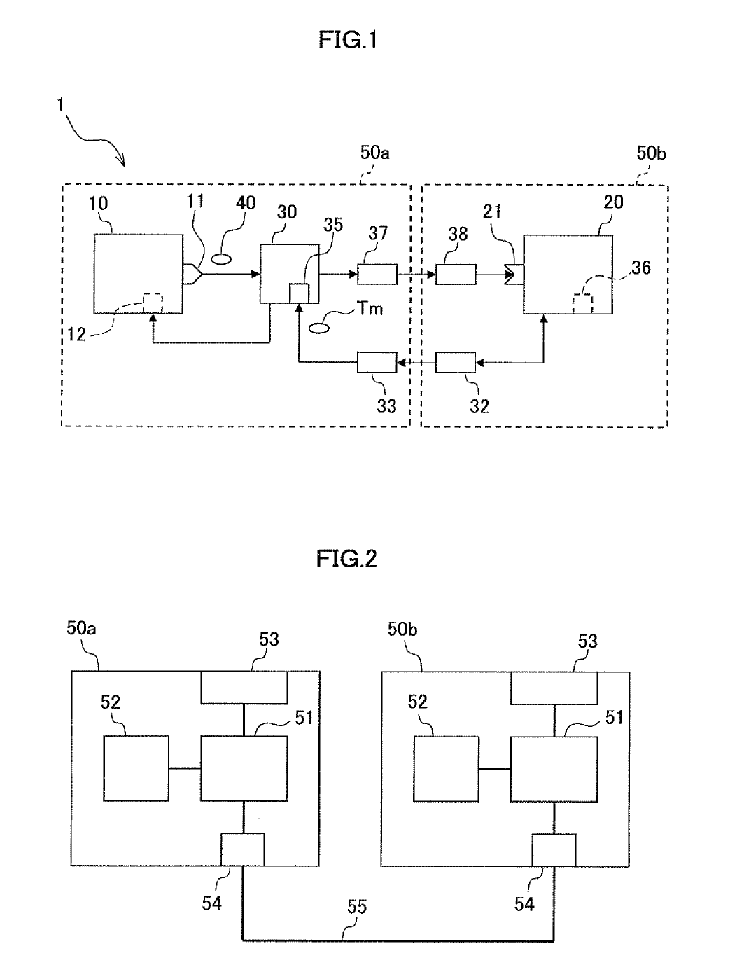

FIG. 1 is a block diagram showing a real-time distributed control system according to an embodiment of the present invention. FIG. 1 exemplarily shows a configuration of the system, a box represents a function, and a line connecting boxes represents a transmission of data or an operation instruction. Actual functions are realized by a hardware of a computer and a software loaded therein. The present invention relates to a basic function of a control system, and various control systems can be configured by using the configuration of this embodiment. In this embodiment, an example of a minimum system including two components will be explained.

A real-time distributed control system 1 of this embodiment includes a transmitting component 10 having a transmitting port 11, and a receiving component 20 having a receiving port 21. The transmitting port 11 and the receiving port 21 are connected each other through a transmission rate monitoring unit 30, an inter-component communication transmitting unit 37, and an inter-component communication receiving unit 38. The transmitting component 10 transmits a message 40 through the transmitting port 11, and the message 40 is transmitted to the receiving port 21 of the receiving component 20 through the transmitting rate monitoring unit 30, the inter-component communication transmitting unit 37, and the inter-component communication receiving unit 38.

Here, the transmitting component 10 is a soft real-time information system software. The receiving component 20 is a hard real-time control system software. The transmitting component 10 transmits the message 40 for giving an operation instruction to the receiving component 20, but such a transmission interval is inconstant. The receiving component 20 not only performs a control operation periodically but also executes an operation setting process corresponding to an operation instruction message when receiving such an operation instruction message from the transmitting component 10.

More specifically, for example, the transmitting component 10 plans a moving of a movable robot comprehensively, generates a destination coordinate, and transmits it as an operation instruction message. The receiving component 20 controls a moving mechanism periodically, and sets a target value for a control to the moving mechanism in accordance with the destination coordinate received from the transmitting component 10 so that the movable robot moves to the destination.

The transmission rate monitoring unit 30 monitors a time interval of the message 40 transmitted from the transmitting port 11, and compares such a time interval with an allowable minimum transmission interval Tm set in a transmission-rate-monitoring-condition memory unit 35. When the message time interval (message transmission interval) is less than Tm (i.e., when the transmission rate of the message 40 exceeds the condition), the transmitting component 10 is once stopped to increase the time interval of the message 40. Here, the allowable minimum transmission interval Tm is a minimum time interval at which a message can be transmitted without deteriorating the hard real-time characteristic of the receiving component 20.

An operation cycle obtaining unit 32 obtains the control cycle of the hard real-time control system from the receiving component 20, determines an allowable minimum transmission interval Tm based on the obtained operation cycle, and transmits the determined allowable minimum transmission interval Tm to a transmission-rate monitoring-condition setting unit 33 (transmission rate setting unit). The transmission-rate-monitoring-condition setting unit 33 writes the received allowable minimum transmission interval Tm in the transmission-rate-monitoring-condition memory unit 35.

In addition, the transmitting component 10 may be provided with an operation mode setting unit 12. Also, the receiving component 20 may be provided with an allowable minimum-reception-interval memory unit 36 (allowable reception interval memory unit). The detail will be discussed later.

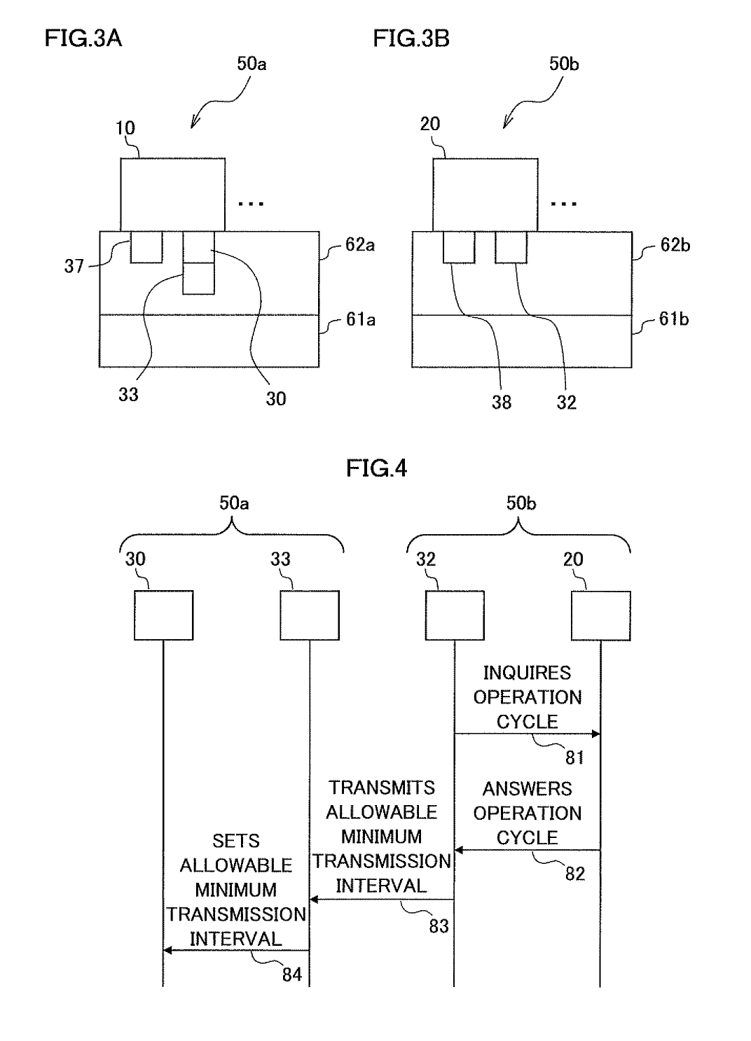

FIG. 2 is a block diagram showing a hardware of the real-time distributed control system. Also, FIG. 3 is a block diagram showing a hierarchical structure of a software for the real-time distributed control system. The real-time distributed control system of this embodiment is realized by hardwares shown in FIG. 2 and softwares shown in FIG. 3 and run on such hardwares. Here, an example in which two computers for control are equipped will be explained.

As shown in FIG. 2, each of a computer 50a (a first computer) and a computer 50b (a second computer) has a processing device (CPU: Central Processing Unit) 51. The processing device 51 is connected to a memory 52 for storing a program and data, an input/output circuit 53, and a communication circuit 54. The computer 50a and the computer 50b are connected each other through the communication circuit 54 and an inter-computer communication channel 55. In addition, in the embodiment shown in FIG. 2, the computer 50a and the computer 50b have the respective processing devices 51 that are different processing devices. The same is true for the memory 52, the input/output circuit 53, and the communication circuit 54. The computer 50a and the computer 50b can be configured by using a multi-core CPU having respective processing devices 51 built in a single integrated circuit. In this case, the communication circuit 54 and the inter-computer communication channel 55 serve as a inter-core communication circuit for exchanging data between two processing devices (cores). The memories 52 and the input/output circuits 53 can be partially or wholly shared.

FIG. 3A shows a hierarchical structure of a software of the computer 50a, and FIG. 3B shows a hierarchical structure of a software of the computer 50b. As shown in FIGS. 3A and 3B, the two computers 50a, 50b have operating systems (OS) 61a, 61b, respectively, as basic softwares, and a middleware 62a (a first middleware) and a middleware 62b (a second middleware) run on respective operating systems. Respective software components that are application softwares further run on respective middlewares. In this case, the transmitting component 10 and the receiving component 20 run.

Because the transmitting component 10 and the receiving component 20 run on the computers 50a, 50b, respectively, the computers 50a, 50b will be referred to as a transmitting computer, and a receiving computer, respectively. In addition, a plurality of software components may further run on the middlewares 62a, 62b.

The transmission rate monitoring unit 30 is built in the transmitting computer 50a like the transmitting component 10, and is included in the middleware 62a on the transmitting computer 50a. An inter-component communication transmitting unit 37 and the transmission-rate-monitoring-condition setting unit 33 are also included in the middleware 62a on the transmitting computer 50a. An inter-component communication receiving unit 38 and the operation cycle obtaining unit 32 are built in the receiving computer 50b, and are included in the middleware 62b on the receiving computer 50b.

The inter-component communication transmitting unit 37 transmits the message 40 to the inter-component communication receiving unit 38 (see FIG. 1). Also, the operation cycle obtaining unit 32 transmits the allowable minimum transmission interval Tm to the transmission-rate-monitoring-condition setting unit 33 (see FIG. 1). Data exchange between the transmitting computer 50a and the receiving computer 50b is physically realized by a communication using the inter-computer communication channel 55. Because the transmission rate monitoring unit 30 and the transmitting component 10 are built in the same transmitting computer 50a, prior to a transmission of the message 40 through the inter-computer communication channel 55, the transmission rate is monitored and an excessive message transmission is suppressed. For this reason, the load to the inter-computer communication channel 55 is reduced, and a delay of another message can be prevented. Also, the load to the receiving computer 50b can be reduced, and a delay of an operation of the receiving component 20 which is built in the receiving computer 50b and which needs a hard real-time characteristic can be prevented.

In addition, in the case of the real-time distributed control system shown in FIG. 1, the minimum configuration with two components is exemplified, but the present invention can be applied to a system having a greater number of components. A single component may be provided with plural transmitting ports 11 and receiving ports 21. In this case, it is appropriate if each pair of the transmitting port 11 for transmitting the message 40 and the receiving port 21 is provided with the transmission rate monitoring unit 30.

Two computers are used in the hardware configurations and the software structures shown in FIGS. 2, 3A and 3B, but three or more computers may be used. In the foregoing example, the transmitting component 10 and the receiving component 20 are realized by respective softwares on different computers, but the transmitting component 10 and the receiving component 20 may be loaded in the same computer. In this case, a virtual communication channel by a software is used instead of the inter-computer communication channel 55.

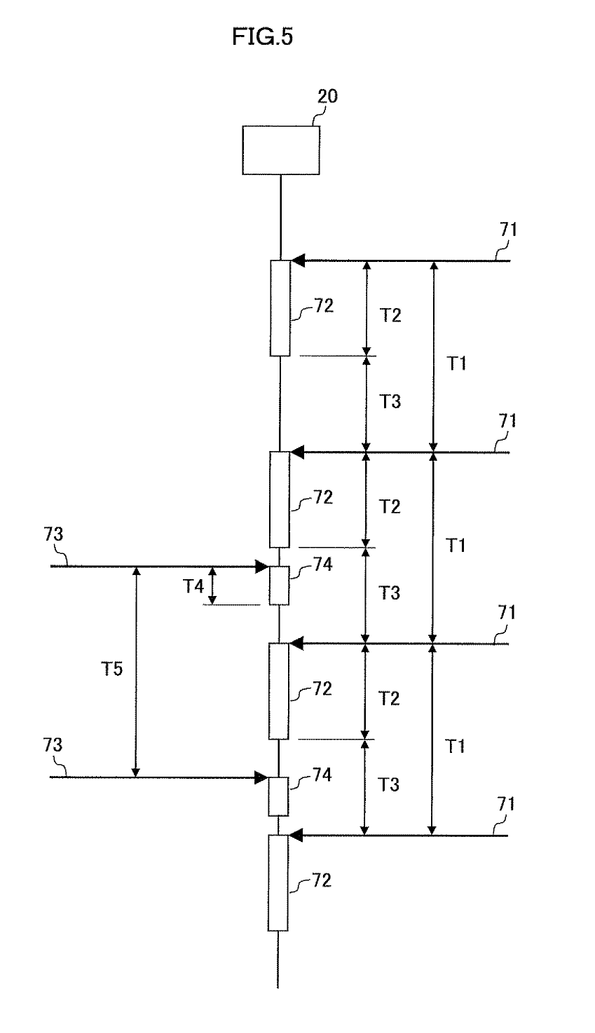

Next, an operation of the real-time distributed control system according to this embodiment will be explained. The operation includes an initial setting operation (see FIG. 4) and a monitoring/controlling operation (see FIGS. 5 to 7).

First, an explanation will be given to the initial setting operation with reference to FIG. 1 as needed.

FIG. 4 is a sequence diagram showing the initial setting operation by the real-time distributed control system. As the system is powered on and activated, the operation cycle obtaining unit 32 inquires the operation cycle to the receiving component 20 (81), the receiving component 20 answers the operation cycle (82), and the operation cycle obtaining unit 32 obtains the operation cycle of the receiving component 20. The operation cycle obtaining unit 32 transmits a value which is equal to the obtained operation cycle as the allowable minimum transmission interval Tm to the transmission-rate-monitoring-condition setting unit 33 (83). The transmission-rate-monitoring-condition setting unit 33 transmits the received allowable minimum transmission interval Tm to the transmission rate monitoring unit 30, and the transmission rate monitoring unit 30 writes (sets) the allowable minimum transmission interval Tm in the transmission-rate-monitoring-condition memory unit 35 (84).

Because the “cycle” of the operation cycle is a period (time) basis, so that the unit thereof is normally a second (symbol: s), and in general, a quantity symbol is T. Also, the allowable minimum transmission interval Tm is normally a second (symbol: s) basis. Accordingly, the operation cycle and the allowable minimum transmission interval Tm are expressed in the same dimension.

Here, the reason why the allowable minimum transmission interval Tm is set based on the operation cycle will be explained.

FIG. 5 is a sequence diagram showing an operation timing for the receiving component. The operation timing of the receiving component 20 which is the hard real-time control system will be explained with reference to FIG. 5. The receiving component 20 is activated by a timer trigger 71 which is generated at an operation cycle T1 which is a certain time interval, and executes a control process 72 periodically. In order to execute the process at the operation cycle T1 without a delay, a process time T2 required for the control process 72 needs to be shorter than the operation cycle T1. That is, a condition in which the end time of the control process 72 is no later than a next trigger time is a deadline condition for realizing the hard real-time characteristic of this system.

If a process unoccupied time is T3, then those times satisfy a relationship that T1=T2+T3. When a process time of an operation setting process 74 to a message transmission 73 for an operation instruction transmitted from the transmitting component 10 is T4, if the process time T4 is longer than the process unoccupied time T3 of the receiving component 20, the completion of the control process 72 will be always delayed from a next trigger.

In the foregoing state, all operation instructions are not accepted at all, so that in such a case, the process times T2 and T4 are shortened by, for example, using a faster computer, and setting is made again in such a way that the process time T4 becomes smaller than the unoccupied time T3. For this reason, it is always assured that the process time T4 is equal to or shorter than the unoccupied time T3, and the operation setting process 74 can be executed at least once time during the operation cycle T1 without disturbing the hard real-time operation.

When the allowable minimum transmission interval Tm (see FIG. 1) is set to be equal to the operation cycle T1, a message time interval T5 of the message transmission 73 which arrives at the receiving component 20 becomes equal to or longer than the operation cycle T1, so that the number of execution of the operation setting process 74 during the operation cycle T1 becomes equal to or less than 1 time, and the hard real-time characteristic can be maintained.

When the initial setting operation completes, the process progresses to a continuous monitoring/controlling operation. Prior to the explanation for the monitoring/controlling operation of this embodiment, however, as a comparative example (a prior art), an operation in a case in which the transmission rate monitoring unit 30 is omitted and the transmitting port 11 of the transmitting component 10 is directly connected to the receiving port 21 of the receiving component 20, and the problem of such a case will be explained.

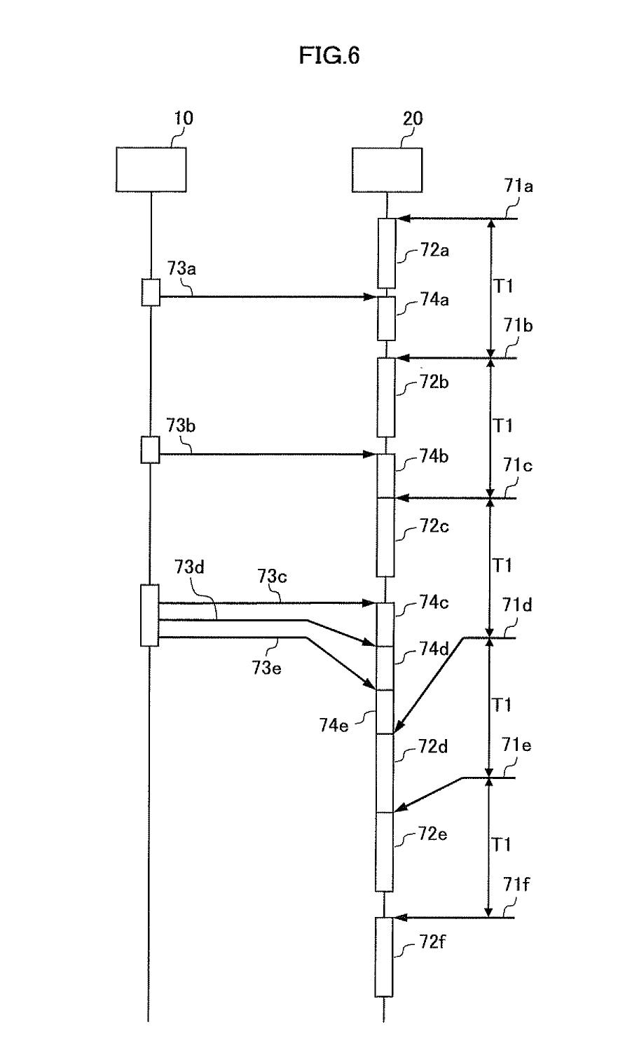

FIG. 6 is a sequence diagram showing an operation timing in a comparative example having no transmission rate monitoring unit. In this case, message transmissions 73a to 73e transmitted from the transmitting component 10 are immediately transmitted to the receiving component 20 without checking the transmission interval. The receiving component 20 receives timer triggers 71a to 71f in order to execute a control process at the operation cycle T1 which is a certain time interval. The receiving component 20 executes operation setting processes 74a to 74e and control processes 72a to 72f corresponding to operation instructions in an order of arrival of messages and triggers. In addition, in FIG. 6, it seems that the receiving component 20 substantially simultaneously receives a message transmission 73e and a timer trigger 71d, but in this example, the message transmission 73e arrives at first.

In the example shown in FIG. 6, regarding message transmissions 73a, 73b, and 73c in message transmissions 73a to 73e, the transmitting component 10 transmits messages at intervals each of which is equal to or longer than the allowable minimum transmission interval Tm (=T1). On the other hand, regarding message transmissions 73d, 73e following the message transmission 73c, messages are successively transmitted at a shorter (less than Tm) time interval. In this example, three message transmissions including the message transmission 73c are performed within a short period. Such a situation may occur when a sensor built in a robot suddenly detects a large number of objects or humans and the software loaded in the transmitting component 10 for planning a movement suddenly changes a destination.

In this case, because there are sufficient intervals among the message transmissions 73a, 73b, and 73c, when the operation setting processes 74a, 74b, and 74c corresponding to those are executed, respective completions of the control processes 72a, 72b, and 72c are not delayed from a next trigger.

On the other hand, the message transmissions 73d and 73e following the message transmission 73c are successively performed at a short time interval, and the operation setting processes 74c, 74d, and 74e are executed between the control process 72c and the control process 72d, and as a result, the completion of the control process 72d will be delayed from a next trigger 71e.

That is, a deadline time elapses and the hard real-time characteristic is deteriorated. As explained above, when the transmitting component 10 intensively creates messages and when such messages are transmitted to the receiving component 20 as those are, the execution timing of the control process may be disturbed. As a result, a problem such that a mechanical device to be controlled generates abnormal vibration may occur.

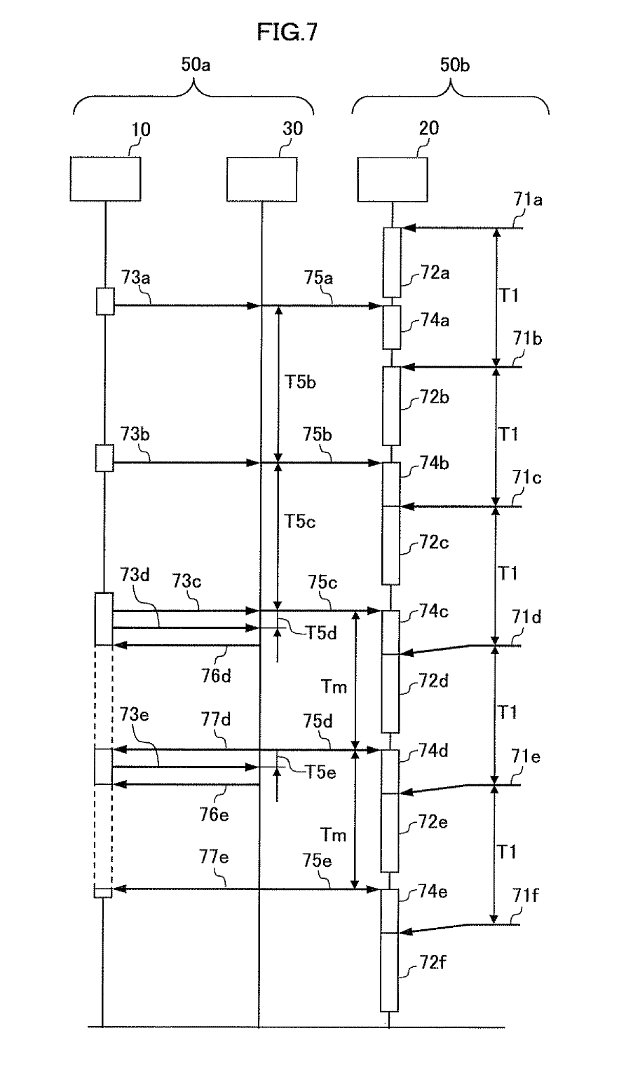

Therefore, according to the real-time distributed control system of this embodiment, a function of monitoring the message transmission rate and of reducing the monitoring rate is equipped. The monitoring/controlling operation of this embodiment will be explained with reference to FIG. 7.

FIG. 7 is a sequence diagram showing a timing of the monitoring/controlling operation in the real-time distributed control system of this embodiment. First, a brief summary thereof will be explained. The message 40 transmitted from the transmitting component 10 (see FIG. 1) is first passed to the transmitting rate monitoring unit 30. The transmitting rate monitoring unit 30 calculates a message time interval T5 which is a difference between a time when the message 40 is received and a time when the message 40 was transmitted at a previous time, and compares the message time interval T5 with the allowable minimum transmission interval Tm (see FIG. 1). When the message time interval T5 is longer than the allowable minimum transmission interval Tm, the message 40 is immediately transmitted to the receiving component 20. On the other hand, when the message time interval T5 is shorter than the allowable minimum transmission interval Tm, the transmitting component 10 is once stopped, and the transmission rate monitoring unit 30 stands by until a time Tm elapses from the previous message transmission. Thereafter, the message 40 is transmitted to the receiving component 20, and the operation of the transmitting component 10 is resumed.

The foregoing operation will be explained in more detail with reference to FIG. 7. In this example, like the comparative example shown in FIG. 6, the transmitting component 10 transmits a message at a time interval equal to or longer than the allowable minimum transmission interval Tm regarding message transmissions 73a, 73b, and 73c, and successively transmits messages regarding message transmissions 73d, 73e following the message transmission 73c.

Regarding the message transmissions 73a, 73b, and 73c, because message time intervals T5b, T5c are longer than the allowable minimum transmission interval Tm, the transmitting rate monitoring unit 30 transfers messages to the receiving component 20 as those are (message transmissions 75a, 75b, and 75c). The operation timing up to this operation is the same as that of the comparative example shown in FIG. 6.

On the other hand, regarding the message transmission 73d, because a message time interval T5d between the previous message transmission 75c and the message transmission 73d to the receiving component 20 is shorter than the allowable minimum transmission interval Tm, the transmission rate monitoring unit 30 once stops the transmitting component 10 in order to expand the message interval, notifies the transmitting component 10 (notification transmission 76d), and stands by until a time Tm elapses from the previous message transmission 75c.

After the time Tm has elapsed from the message transmission 75c, the transmission rate monitoring unit 30 transmits a message to the receiving component 20 (message transmission 75d) and notifies the transmitting component 10 to start its operation again (notification transmission 77d). In addition, the message transmission 73d and the message transmission 75d have the same message content.

When receiving the notification for starting the operation again, the transmitting component 10 starts its operation again, and immediately transmits a next message (message transmission 73e), so that the transmission rate monitoring unit 30 notifies the transmitting component 10 (notification transmission 76e) in order to once stop the transmitting component 10 like the case of the message transmission 73d, and stands by until a time Tm elapses from the previous message transmission 75d. Thereafter, the transmission rate monitoring unit 30 transmits a message to the receiving component 20 (message transmission 75e), notifies the transmitting component 10 to start its operation again (notification transmission 77e), and the transmitting component 10 starts its operation again. The message transmission 73e and the message transmission 75e have the same message content.

Through the foregoing operation, when the transmitting component 10 attempts to successively transmit messages, the transmission rate monitoring unit 30 once stops the transmitting component 10 to expand a message interval, and the message transmission interval to the receiving component 20 is controlled so as to be equal to or longer than the allowable minimum transmission interval Tm. For this reason, even if the operation setting processes 74c, 74d, and 74e are executed, respective completions of the control processes 72d, 72e are not delayed from a next trigger, and the hard real-time characteristic can be maintained.

In addition, in order to once stop the transmitting component 10, a task (an execution thread) which is executing the software of the transmitting component 10 may be stopped using the function of the OS. Alternatively, when the transmitting component 10 and the software of the transmission rate monitoring unit 30 are executed by the same task, if the transmission rate monitoring unit 30 is once stopped until a time when a message transmission is enabled, the transmitting component 10 is also stopped.

As explained above, in the real-time distributed control system of this embodiment, a message transmission interval from the transmitting component 10 to the receiving component 20 is automatically controlled so as not to be shorter than the allowable minimum transmission interval Tm, so that without adding any special process of managing a message transmission rate to the program of the transmitting component 10, a delay of the control operation by the receiving component 20 is prevented, the hard real-time characteristic is maintained, and the load to a developer is reduced.

Also, in the foregoing configuration, when the transmission rate monitoring unit 30 suppresses the message transmission 73, the message which has been transmitted by the transmitting component 10 is not lost, and all messages are transmitted to the receiving component 20, so that a time is delayed but there is an advantage that all operation instructions can be completed. Also, if the transmitting component 10 has an error in its design and generates abnormally large amount of messages, the message transmission rate is automatically suppressed, and the hard real-time characteristic of the receiving component 20 is maintained, thereby suppressing an abnormal operation of the mechanical device.

The feature that the message is not lost has a large effect in a control system for, in particular, a robot/mechatronics device, etc. For example, in this embodiment, the transmitting component 10 plans a movement of a robot, generates a coordinate of a destination, and transmits an operation instruction message to the receiving component 20, and the receiving component 20 controls the robot to move in accordance with the received message.

Here, assuming that, for example, the transmitting component 10 generates more target coordinates than those generated in a normal situation because a large number of obstacles are found, operation instruction messages are transmitted at a fast rate, and resulting in a situation where it is difficult to maintain the real-time characteristic of the receiving component 20 as it stands. At this time, if the number of messages transmitted by the transmitting component 10 are thinned out in order to expand the message transmission interval, a movement pathway of the robot becomes different from the pathway planned by the transmitting component 10, and the robot is caused to move along the pathway, a portion of which is shortcut. In this case, if there is an obstacle on the shortcut pathway, the robot may collide against the obstacle. On the other hand, if the number of messages are not thinned out, and if the transmitting component 10 is once stopped in order to expand the message transmission interval, the movement timing of the robot may be delayed but the robot can move along the pathway planned as it is, so that the safeness can be ensured.

As explained above, in the control system for a robot/mechatronics devices, etc., a delay of the arrival time of a message is often permitted but the lack of messages is not allowed in general. In this embodiment, all messages are transmitted, so that there is an effect that the safeness can be ensured easily.

In addition, when the transmission rate monitoring unit 30 is activated and the process of the transmitting component 10 is delayed, it is necessary in some cases to execute a recovery process (a recovery mode) which decreases the motion speed of the device instead of continuing the operation as it is. For this reason, as shown in FIG. 1, the transmitting component 10 may be provided with the operation mode setting unit 12 in order to enable selection/changing between the normal mode and the recovery mode, and when the transmission rate monitoring unit 30 once stops the transmitting component 10, the operation mode setting unit 12 may change the operation mode from the normal mode to the recovery mode. In this case, the transmitting component 10 is programmed so as to change the process content in accordance with the operation mode (the normal mode or the recovery mode).

More specifically, the transmitting component 10 includes the operation mode setting unit 12 which can change the operation mode between the normal mode which allows the transmitting component 10 to operate in a normal operation cycle and the recovery mode which slows down the operation cycle. When receiving an instruction that the transmission rate of the message 40 does not satisfy the monitoring condition from the transmission rate monitoring unit 30, the operation mode setting unit 12 changes the operation mode from the normal mode to the recovery mode.

Because the allowable minimum transmission interval Tm is automatically set through the initial setting operation when the system is activated based on the operation cycle of the receiving component 20, it is unnecessary to individually set the monitoring condition of the transmission rate monitoring unit 30, thereby reducing the load to the developer. Also, when the combination of the transmitting component 10 and the receiving component 20 changes and thus the monitoring condition changes, a new setting and a changing in the program are unnecessary, and the allowable minimum transmission interval Tm is automatically set to be an appropriate value.

Because the allowable minimum transmission interval Tm is set just one time by the transmission-rate-monitoring-condition setting unit 33 when the system is activated, the load to the inter-computer communication channel 55 is light.

In the foregoing embodiment, the transmission-rate-monitoring-condition setting unit 33 sets the allowable minimum transmission interval Tm at a value which is equal to the operation cycle T1 of the receiving component 20. Instead of this configuration, the allowable minimum transmission interval Tm may be set at a value obtained by multiplying the operation cycle T1 by a certain multiplying factor. This enables adjustment of balancing between the efficiency of the process and the certainty of the real-time characteristic.

Also, in the foregoing embodiment, the operation cycle obtaining unit 33 determines the allowable minimum transmission interval Tm based on the operation cycle T1 of the receiving component 20. Instead of the above configuration, as shown in FIG. 1, the receiving component 20 may be provided with the allowable-minimum-reception-interval memory unit 36, an allowable minimum message reception interval may be set manually beforehand, and the operation cycle obtaining unit 32 may determine the allowable minimum transmission interval Tm which is the value set in the allowable-minimum-reception-interval memory unit 36. This enables more flexible setting of the transmission rate monitoring condition although the steps of the setting increase. In addition, in this case, in order to prevent a setting error, when a value shorter than the operation cycle T1 of the receiving component 20 is set through a developing tool for setting the allowable minimum reception interval Tm, an alert may be issued.

Instead of the configuration in which the transmission-rate-monitoring-condition setting unit 33 transfers the allowable minimum transmission interval Tm from the receiving computer 50b to the transmitting computer 50a at the time of initial setting operation, the allowable minimum transmission interval Tm may be set in the transmission-rate-monitoring-condition memory unit 35 beforehand. In this case, when the receiving component 20 is replaced and the system configuration is changed, the monitoring condition for the transmission rate monitoring unit 30 is not automatically changed and a resetting becomes necessary. However, because the operation cycle obtaining unit 32 and the transmission-rate-monitoring-condition setting unit 33 become unnecessary, the size of the middleware can be reduced.

In the foregoing embodiment, the transmission rate is monitored based on the message transmission interval. Instead of the above configuration, the transmission rate may be monitored based on the number of transmitted messages within a monitoring cycle of a certain time. In this case, the transmission rate monitoring unit 30 counts the number of messages during the monitoring cycle, and when the number of messages exceeds an allowable maximum message number, the transmitting component 10 is stopped until the start time of a next monitoring cycle. In this scheme, how to monitor and control becomes complicated, but a more flexible message-transmission-rate control is enabled such that transmission of successive messages up to two messages can be permitted.

### Modified Example

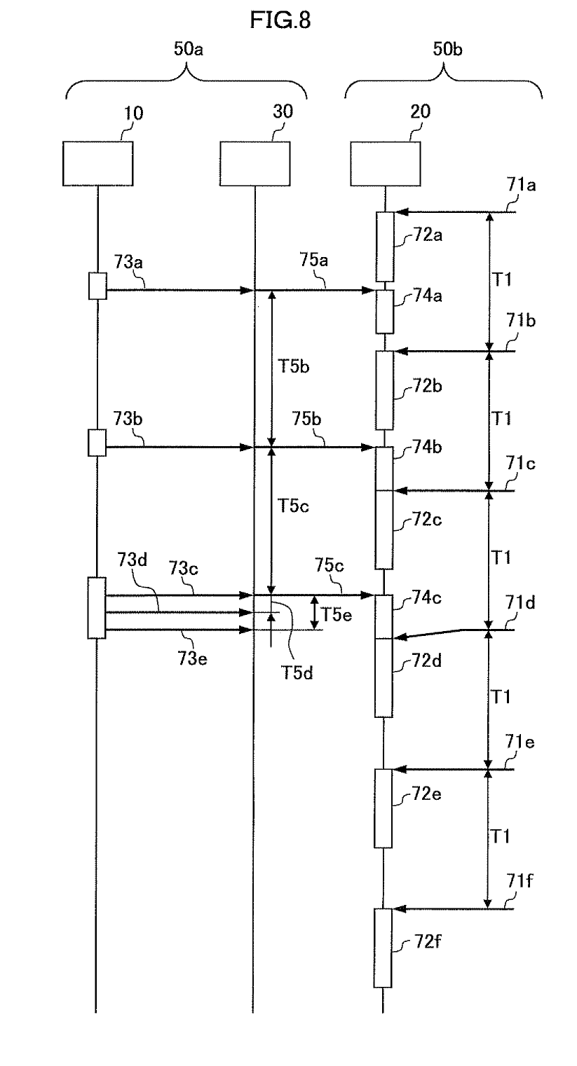

In the embodiment shown in FIG. 7, when the message transmission interval is shorter than the allowable minimum transmission interval Tm, the transmission component 10 is once stopped in order to expand the message transmission interval, and the message transmission is suppressed. In other words, the embodiment in which the number of messages is not thinned out was explained above. In a modified example shown in FIG. 8, instead of the foregoing configuration, a message is not transmitted to the receiving component 20 but is discarded (thinned out), thereby suppressing a message transmission.

FIG. 8 is a sequence diagram showing a timing of another monitoring/controlling operation in the real-time distributed control system of this embodiment. In this case, because message time intervals T5d, T5e relative to message transmissions 73d, 73e are shorter than the allowable minimum transmission interval Tm (see FIG. 1), the transmission rate monitoring unit 30 does not transmit the message to the receiving component 20 but discards such a message. In this way, an operation setting process to the message transmissions 73d, 73e is not executed, respective completions of control processes 72d, 72e do not delay from the next trigger, and the hard real-time characteristic can be maintained.

In this case, because the transmitting component 10 is not stopped, the operation speed of the transmitting component 10 becomes fast, thereby improving the process efficiency. When this scheme is applied, however, it is necessary to design the system so there is no harm in continuing the operation even if some of the messages do not arrive at the receiving component 20. For example, when the transmitting component 10 has a function of detecting an absolute position based on a radio wave from an artificial satellite, and transmits the absolute position to the receiving component 20 in order to correct the position detected based on the rotation number of a wheel, there is no harm if some of the messages do not arrive at the receiving component 20, so that the foregoing scheme can be used.

The real-time distributed control system of this embodiment has a function of monitoring and controlling the message transmission rate in the middleware in order to prevent a delay of execution by the hard real-time control system, and performs a real-time distributed control with a high reliability. Because the message transmission rate monitoring condition is automatically set based on a value obtained by the operation cycle obtaining unit 32, the load to the developer can be reduced, and it is possible to easily cope with a configuration change.

What is claimed is:

1. A real-time distributed control system including a first computer and a second computer, the second computer being configured to receive a message from the first computer to be controlled in a real time manner, wherein
the second computer comprises:
a receiving component which receives the message; and
an operation cycle obtaining unit which obtains an operation cycle of the receiving component upon activation of the real-time distributed control system, and transmits a monitoring condition associated with the obtained operation cycle to the first computer, and
the first computer comprises:
a transmitting component which transmits the message;
a transmission rate setting unit which sets the monitoring condition in a transmission-rate-monitoring-condition memory unit; and
a transmission rate monitoring unit which monitors a transmission rate from the transmitting component based on the monitoring condition stored in the transmission-rate-monitoring-condition memory unit, and suppresses a transmission interval of the message when the transmission rate of the message does not satisfy the monitoring condition.

2. The real-time distributed control system according to claim 1, wherein
the operation cycle obtaining unit transmits a value which is equal to the obtained operation cycle as an allowable minimum transmission interval to the transmission rate setting unit, and
the transmission rate setting unit sets the received allowable minimum transmission interval as the monitoring condition in the transmission-rate-monitoring-condition memory unit.

3. The real-time distributed control system according to claim 2, wherein
when detecting that the transmission interval of the message is shorter than the allowable minimum transmission interval, the transmission rate monitoring unit once stops the transmitting component to delay a transmission of the message from the transmitting component.

4. The real-time distributed control system according to claim 2, wherein
when detecting that the transmission interval of the message is shorter than the allowable minimum transmission interval, the transmission rate monitoring unit discards the message.

5. The real-time distributed control system according to claim 1, wherein
the transmitting component includes an operation mode setting unit which changes an operation mode between a normal mode in which the transmitting component operates in a normal operation cycle and a recovery mode in which the operation cycle is slowed down, and
the operation mode setting unit changes the operation mode from the normal mode to the recovery mode when receiving an instruction that the transmission rate of the message does not satisfy the monitoring condition from the transmission rate monitoring unit.

6. The real-time distributed control system according to claim 1, wherein
the receiving component includes an allowable reception interval memory unit which stores an allowable reception interval cycle, and
the operation cycle obtaining unit sets the allowable reception interval cycle as the monitoring condition when the allowable reception interval cycle is longer than the obtained operation cycle.

7. The real-time distributed control system according to claim 1, wherein
the first computer includes a first middleware which monitors a transmission of the message from the transmitting component, and the first middleware includes the transmission rate setting unit and the transmission rate monitoring unit, and
the second computer includes a second middleware which monitors an operation state of the receiving component, and the second middleware includes the operation cycle obtaining unit.

8. A real-time distributed control method for a system including a first computer and a second computer,
the second computer comprises:
a receiving component that receives a message, and
an operation cycle obtaining unit which obtains an operation cycle of the receiving component,
the first computer comprises:
a transmitting component which transmits the message, and
a transmission rate setting unit which sets a monitoring condition in a transmission-rate-monitoring-condition memory unit, and
a transmission rate monitoring unit which monitors a transmission rate from the transmitting component based on the monitoring condition stored in the transmission-rate-monitoring-condition memory unit, wherein
the second computer is configured to receive the message from the first computer to be controlled in a real time manner, and wherein
the operation cycle obtaining unit transmits the monitoring condition associated with the operation cycle obtained from the receiving component to the transmission rate setting unit upon activation of the system,
the transmission rate setting unit sets the received monitoring condition in the transmission-rate-monitoring-condition memory unit, and
the transmission rate monitoring unit suppresses a transmission interval of the message when a transmission rate of the message does not satisfy the monitoring condition.

9. The real-time distributed control method according to claim 8, wherein
the operation cycle obtaining unit transmits a value which is equal to the obtained operation cycle as an allowable minimum transmission interval to the transmission rate setting unit, and
the transmission rate setting unit sets the received allowable minimum transmission interval as the monitoring condition in the transmission-rate-monitoring-condition memory unit.

10. The real-time distributed control method according to claim 9, wherein
when detecting that the transmission interval of the message is shorter than the allowable minimum transmission interval, the transmission rate monitoring unit once stops the transmitting component to delay a transmission of the message from the transmitting component.

11. A robot including a first computer and a second computer, the second computer being configured to receive a message from the first computer to be controlled, wherein
the second computer comprises:
a receiving component which receives the message; and
an operation cycle obtaining unit which obtains an operation cycle of the receiving component upon activation of the robot, and transmits a monitoring condition associated with the obtained operation cycle to the first computer, and
the first computer comprises:
a transmitting component which transmits the message;
a transmission rate setting unit that sets the monitoring condition in a transmission-rate-monitoring-condition memory unit; and
a transmission rate monitoring unit which monitors a transmission rate from the transmitting component based on the monitoring condition stored in the transmission-rate-monitoring-condition memory unit, and suppresses a transmission interval of the message when the transmission rate of the message does not satisfy the monitoring condition.

12. The robot according to claim 11, wherein
the operation cycle obtaining unit transmits a value which is equal to the obtained operation cycle as an allowable minimum transmission interval to the transmission rate setting unit, and
the transmission rate setting unit sets the received allowable minimum transmission interval as the monitoring condition in the transmission-rate-monitoring-condition memory unit.

13. The robot according to claim 12, wherein
when detecting that the transmission interval of the message is shorter than the allowable minimum transmission interval, the transmission rate monitoring unit once stops the transmitting component to delay a transmission of the message from the transmitting component.
